(19) United States
(12) Patent Application Publication
(10) Pub. No.: US 2025/0042143 A1
(43) Pub. Date: Feb. 6, 2025

(54) WATERTIGHT MEMBRANE WITH IMPROVED VAPOR PERMEABILITY

(71) Applicant: SIKA TECHNOLOGY AG, Baar (CH)

(72) Inventors: Wilfried CARL, Kreuzlingen (CH); Sabina HOLDENER, Schachen (CH); Martin ROHRER, Sachseln (CH); Shenghua XU, Shanghai (CN); Blaise LEEBER, Burlington, MA (US); Qin WEI, Shanghai (CN)

(73) Assignee: SIKA TECHNOLOGY AG, Baar (CH)

(21) Appl. No.: 18/716,200

(22) PCT Filed: Jan. 17, 2023
(86) PCT No.: PCT/EP2023/051041

§ 371 Date: Jun. 4, 2024

(30) Foreign Application Priority Data
Jan. 25, 2022 (WO) PCT/CN2022/073739

(51) Int. Cl. B32B 27/12; B32B 5/02; B32B 27/18; B32B 27/30; E04B 1/62

(52) U.S. Cl. CPC B32B 27/12; B32B 5/02; B32B 27/18; B32B 27/304; E04B 1/625; B32B 2260/021; B32B 2260/046; B32B 2264/0214; B32B 2264/303; B32B 2270/00; B32B 2307/7265; B32B 2307/7376; B32B 2419/06

(57) ABSTRACT

A sealing element includes a waterproofing layer having a first and a second major surface and including at least one powdered superabsorber polymer, and optionally a reinforcement layer fully embedded into the waterproofing layer or adhered to one of the major surfaces of the waterproofing layer, wherein the waterproofing layer is a polymeric layer including at least one polymer or a bitumen layer including bitumen. A building structure includes a roof or wall substrate, an insulation board, and a sealing element arranged between the roof or wall substrate and the insulation board, and the sealing element is used as a roof or wall breather membrane.

### TECHNICAL FIELD

The invention relates to the field of sheet-like building materials that are water impermeable but permit transmission of water vapor through them. Particularly, the invention relates to breather membranes that are used in roof and wall structures.

### BACKGROUND OF THE INVENTION

In several applications, waterproofing of roof structures is required, but, on the other hand, some water vapor permeability (WVP) is needed to avoid moisture condensation on the inside of the building structure with negative effects, such as growth of mold. The same holds even more for airtight facade sheets, which gain increasing importance due to energy saving efforts.

Sheet-like elements having a relatively high water vapor permeability, typically of <5 m, such as <2 m, as measured by equivalent air layer thickness (Sd value) according to ISO 12572 standard, are commonly used as “breather membranes”. These types of membranes can be used as roof underlays installed to the outer side of the insulation, for example, either over or under the counter-battens on a pitched roof to allow water vapor to escape from inside a building and to prevent any water, most commonly rain, to enter the building. Breather membranes can also be used as house wraps, which function as a weather-resistant barrier preventing rain from getting into the wall assembly while allowing water vapor to pass to the exterior of the building.

Allowing moisture from either direction be to build up within a stud or a cavity in a wall structure can lead to a growth in mold. Furthermore, fiberglass and cellulose insulation will lose their heat insulation properties in the presence of heat-conducting moisture. Outside the construction industry, waterproof breathable fabrics (WPBF) are commonly used in outerwear for winter sports, sailing, apparel, raincoats, military/police jackets, backpacks, tents, cargo raps, and footwear, for example.

The fundamental difference between breather membranes and vapor retarder/barrier membranes is that the latter aim at preventing water vapor getting into a wall from the inside of the building structure, whereas a breather membrane keeps water from getting into the wall from the outside of the building but allows any water vapor that is already in there to escape. Consequently, a vapor retarder/barrier is installed below an insulation layer whereas a breather membrane is typically arranged on above the insulation layer. In terms of vapor permeability properties, a vapor retarder/control layer typically has a Sd value of >10 m and a vapor tight membrane a Sd value of >100 m, whereas a breather membrane has a Sd value of <5 m, preferably <2.5 m.

State-of-the-Art breather membranes either comprise a thin hydrophobic microporous film or a thin hydrophilic film to provide the membrane with the desired water vapor permeability. Published application WO 01/28770 A1 discloses a breathable membrane comprising a microporous polymeric film and a top layer of a filamentous or fibrous polymeric fabric. Breather membranes comprising a microporous film and having a very low Sd value, such as <0.1, have the general disadvantage of exhibiting a very low mechanical strength due to the low thickness and high porosity of the membrane. Furthermore, microporous membranes loose most of their function when moisture condenses resulting in blocking the micropores. Consequently, transport of water vapor through a breather membrane in a pitched roof structure is prevented once condensation of vapor inside the structure has occurred.

For this reason, the construction sector favors use of monolithic breather membranes based on use of hydrophilic polymers, such as thermoplastic polyurethanes (TPU). However, a sufficiently low Sd value can only be reached by using very thin sheets with a thickness of 30-50 μm. Consequently, breather membranes based on monolithic hydrophilic films are typically equipped with protective layers, such as felt layers, on both sides of the film, to improve the mechanical properties of the membrane.

There thus remains a need for a novel type of breather membrane having a Sd value of <10 m, which membrane has superior mechanical properties compared to breather membranes or prior art based on use of microporous layers and/or hydrophilic polymer films.

### SUMMARY OF THE INVENTION

The object of the present invention is to provide a sealing element that is suitable for use an improved breather membrane in roof structures as well as in wall structures (house wrap).

Another object of the present invention is to provide a breather membrane that can be produced with decreased costs compared to the breather membranes of prior art.

The subject of the present invention is a sealing element as defined in claim 1.

It has been found out that the water vapor permeability of a polymeric or bituminous waterproofing layer can be significantly increased by moderate additions of a powdered superabsorber while still preserving sufficient mechanical properties required for a waterproofing layer to be used as a roof or wall breather membrane. Consequently, such sealing elements based on use of such waterproofing layers can solve or at least mitigate the problems of the State-of-the-Art breather membranes.

One of the advantages of the sealing element of the present invention is that it can be produced using a simplified and cost efficient production process based on single layer extrusion.

Other subjects of the present invention are presented in other independent claims. Preferred aspects of the invention are presented in the dependent claims.

### BRIEF DESCRIPTION OF THE DRAWINGS

FIG. 1 shows a cross-section of a sealing element (1) composed of a waterproofing layer (2).

FIG. 2 shows a cross-section of a sealing element (1) comprising a waterproofing layer (2) and a reinforcing layer (3) fully embedded into the waterproofing layer (2).

FIG. 3 shows a cross-section of a sealing element (1) comprising a waterproofing layer (2) and a reinforcing layer (3) adhered to the first major surface of the waterproofing layer.

FIG. 4 shows a cross-section of a sealing element (1) comprising a waterproofing layer (2), first reinforcing layer (3) adhered to the first major surface and a second reinforcing layer (3′) adhered to the second major surface of the waterproofing layer (2).

FIG. 5 shows a cross-section of a sealing element (1) comprising a waterproofing layer (2), a pressure sensitive adhesive layer (4) covering the second major surface of the waterproofing layer (2), and a release liner (5).

FIG. 6 shows a cross-section of a sealing element (1) comprising a waterproofing layer (2), a reinforcing layer (3) adhered to the first major surface of the waterproofing layer, a pressure sensitive adhesive layer (4) covering the second major surface of the waterproofing layer (2), and a release liner (5).

FIG. 7 shows a cross-section of a sealing element (1) comprising a waterproofing layer (2), a first reinforcing layer (3) adhered to the first major surface of the waterproofing layer, a second reinforcing layer (3′) adhered to the second major surface of the waterproofing layer (2), a pressure sensitive adhesive layer (4) covering the outward facing surface of the second reinforcing layer (3′), and a release liner (5) covering the outward facing surface of the pressure sensitive adhesive layer (4).

FIG. 8 shows a cross-section of a sealing element (1) comprising a waterproofing layer (2), a first pressure sensitive adhesive layer (4) covering the second major surface of the waterproofing layer (2), a first release liner (5) covering the outward facing surface of the first pressure sensitive adhesive layer (4), a second pressure sensitive adhesive layer (4′) covering the second major surface of the waterproofing layer (2), and a second release liner (5′) covering the outward facing surface of the second pressure sensitive adhesive layer (4′).

### DETAILED DESCRIPTION OF THE INVENTION

The subject of the present invention a sealing element (1) comprising
i) A waterproofing layer (2) having a first and a second major surface and comprising at least one powdered superabsorber polymer SAP,
ii) Optionally a reinforcement layer (3) fully embedded into the waterproofing layer (2) or adhered on one of the major surfaces of the waterproofing layer (2),
wherein the waterproofing layer (2) is a polymeric layer comprising at least one polymer P or a bitumen layer comprising bitumen B and at least one modifying polymer MP.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “molecular weight” refers to the molar mass (g/mol) of a molecule or a part of a molecule, also referred to as “moiety”. The term “average molecular weight” refers to number average molecular weight (Mn) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “melting temperature” designates a temperature at which a material undergoes transition from the solid to the liquid state. The melting temperature (Tm) is preferably determined by differential scanning calorimetry (DSC) according to ISO 11357-3 standard using a heating rate of 2° C./min. The measurements can be performed with a Mettler Toledo DSC 3+ device and the Tm values can be determined from the measured DSC-curve with the help of the DSC-software. In case the measured DSC-curve shows several peak temperatures, the first peak temperature coming from the lower temperature side in the thermogram is taken as the melting temperature (Tm).

The term “glass transition temperature” (Tg) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one thermoplastic polymer” refers to the sum of the individual amounts of all thermoplastic polymers contained in the composition. Furthermore, in case the composition comprises 20 wt.-% of at least one thermoplastic polymer, the sum of the amounts of all thermoplastic polymers contained in the composition equals 20 wt.-%.

The term “room temperature” designates a temperature of 23° C.

The sealing element of the present invention comprises a waterproofing layer having a first and a second major surfaces, i.e., a top and a bottom surface defining a thickness there between. The waterproofing layer can either be a polymeric layer or a bitumen layer. The term “polymeric layer” refers to a layer comprising a continuous phase composed of one or more main polymers.

The waterproofing layer comprises at least one powdered superabsorber polymer SAP.

The term “superabsorber polymer” or “super absorbent polymer” refers to special class of polymers that can absorb and retain extremely large amounts of a liquid relative to their own mass. For example, such a superabsorber polymer may be able to absorb up to 300 times its weight of water. The expression “powdered” is understood to mean that the superabsorber polymer is present in the waterproofing layer as solid particles.

Preferably, the waterproofing layer comprises at least 1.5 wt.-%, preferably at least 2.5 wt.-%, particularly not more than 50 wt.-%, preferably not more than 45 wt.-%, based on the total weight of the waterproofing layer, of the at least one powdered superabsorber polymer SAP.

The weight of the at least one powdered superabsorber polymer SAP in the waterproofing layer refers in the present disclosure to the amount of dry polymer, i.e., to the weight of the at least one powdered superabsorber polymer SAP without the amount of water, which may be present as absorbed in the powdered superabsorber polymer SAP.

According to one or more embodiments, the waterproofing layer comprises 2.5-45 wt.-%, preferably 5-40 wt.-%, more preferably 7.5-35 wt.-%, even more preferably 10-35 wt.-%, still more preferably 15-35 wt.-%, based on the total weight of the waterproofing layer, of the at least one powdered superabsorber polymer SAP

The type of the at least one powdered superabsorber polymer SAP contained in the waterproofing layer is not particularly restricted. Suitable powdered superabsorber polymers include known homo- and co-polymers of (meth) acrylic acid, (meth) acrylonitrile, (meth) acrylamide, vinyl acetate, vinyl pyrrolidone, maleic acid, maleic anhydride, itaconic acid, itaconic anhydride, vinyl sulfonic acid or hydroxyalkyl esters of such acids, wherein 0-95% by weight of the acid groups have been neutralized with alkali or ammonium groups and wherein these polymers/copolymers are crosslinked by means of polyfunctional compounds.

Suitable powdered superabsorber polymers are commercially available under the trade name of HySorb® (from BASF), under the trade name of FAVOR® and Creabloc® (both from Evonik Industries), and under the trade name of AQUALIC® CA (from Nippon Shokubai).

The at least one powdered super absorber polymer SAP preferably has a particle size, which enables it to be evenly distributed into the matrix of the waterproofing layer. Preferably, the at least one powdered superabsorber polymer SAP has a median particle size d₅₀ of not more than 350 μm, more preferably not more than 250 μm, even more preferably not more than 150 μm.

The term “median particle size d₅₀” refers in the present document to a particle size below which 50% of all particles by mass are smaller than the d₅₀ value. The particle size distributions can be determined by sieve analysis according to the method as described in ASTM C136/C136M-14 standard (“Standard Test Method for Sieve Analysis of Fine and Coarse Aggregates).

According to one or more embodiments, the at least one powdered superabsorber polymer SAP has a median particle size d₅₀ of 2.5-200 μm, preferably 5-150 μm, more preferably 15-100 μm.

The waterproofing layer is preferably not tacky to touch at a temperature of 23° C. Whether a layer material is “tacky to the touch” at a specific temperature can be easily determined by pressing the surface of the layer at the specific temperature with a finger. In doubtful cases, the “tackiness” can be determined by spreading powdered chalk on the surface of the layer at the specific temperature and subsequently tipping the surface so that the powdered chalk falls off. If the residual powdered chalk remains visibly adhering to the surface, the layer is considered tacky at the specific temperature.

According to one or more embodiments, the waterproofing layer has a loop tack adhesion to a glass plate measured at a temperature of 23° C. of not more than 1.0 N/25 mm, preferably not more than 0.5 N/25 mm, more preferably not more than 0.1 N/25 mm, even more preferably 0 N/25 mm. The loop tack adhesion can be measured using a “FINAT test method no. 9 (FTM 9) as defined in FINAT Technical Handbook, 9th edition, published in 2014.

According to a first embodiment, the waterproofing layer (2) is a polymeric layer comprising, in addition to the at least one powdered superabsorber polymer SAP, at least one polymer P.

Generally, the type of the at least one polymer P is not particularly restricted. Suitable polymers for use in the polymeric layer include thermoplastic polymers and rubbers.

The term “rubber” designates in the present disclosure a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. As used herein, the term “rubber” may be used interchangeably with the term “elastomer.”

Preferably, the at least one polymer P is selected from polyolefins, halogenated polyolefins, polyvinylchloride (PVC), rubbers, and ketone ethylene esters (KEE).

Term “polyolefin” refers in the present disclosure to homopolymers and copolymers obtained by polymerization of olefin monomers optionally with other types of comonomers.

According to one or more embodiments, the at least one polymer P is selected from polyethylene (PE), ethylene copolymers, polypropylene (PP), propylene copolymers, ethylene-vinyl acetate copolymer (EVA), ethylene-acrylic ester copolymers, polyvinylchloride (PVC), polyethylene terephthalate (PET), polyamide (PA), polystyrene (PS), polyamides (PA), chlorosulfonated polyethylene (CSPE), polyisobutylene (PIB), ethylene propylene diene monomer (EPDM), butyl rubber, halogenated butyl rubber, natural rubber, chloroprene rubber, synthetic 1,4-cis-polyisoprene, polybutadiene, ethylene-propylene rubber (EPR), styrene-butadiene rubber (SBR), isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

According to one or more preferred embodiments, the at least one polymer P is selected from polyethylene (PE), ethylene copolymers, polypropylene (PP), propylene copolymers, ethylene-vinyl acetate copolymer (EVA), ketone ethylene esters (KEE), polyvinylchloride (PVC), and ethylene propylene diene monomer (EPDM).

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomer species are called terpolymers and quaterpolymers, respectively.

Suitable polyethylenes (PE) for use as the at least one polymer P include low density polyethylene (LDPE), linear low density polyethylene (LLDPE), and high density polyethylene (HDPE), preferably having a melting temperature (Tₘ) determined by differential scanning calorimetry (DSC) according to ISO 11357-3:2018 standard using a heating rate of 2° C./min of at or above 85° C., preferably at or above 95° C., more preferably at or above 105° C.

Suitable ethylene copolymers for use as the at least one polymer P include random and block copolymers of ethylene and one or more C3-C20 α-olefin monomers, in particular one or more of propylene, 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of ethylene-derived units, based on the weight of the copolymer.

Suitable ethylene random copolymers include, for example, ethylene-based plastomers, which are commercially available, for example, under the trade name of Affinity®, such as Affinity® EG 8100G, Affinity® EG 8200G, Affinity® SL 8110G, Affinity® KC 8852G, Affinity® VP 8770G, and Affinity® PF 1140G (all from Dow Chemical Company); under the trade name of Exact®, such as Exact® 3024, Exact® 3027, Exact® 3128, Exact® 3131, Exact® 4049, Exact® 4053, Exact® 5371, and Exact® 8203 (all from Exxon Mobil); and under the trade name of Queo® (from Borealis AG) as well as ethylene-based polyolefin elastomers (POE), which are commercially available, for example, under the trade name of Engage®, such as Engage® 7256, Engage® 7467, Engage® 7447, Engage® 8003, Engage® 8100, Engage® 8480, Engage® 8540, Engage® 8440, Engage® 8450, Engage® 8452, Engage® 8200, and Engage® 8414 (all from Dow Chemical Company).

Suitable ethylene-α-olefin block copolymers include ethylene-based olefin block copolymers (OBC), which are commercially available, for example, under the trade name of Infuse®, such as Infuse® 9100, Infuse® 9107, Infuse® 9500, Infuse® 9507, and Infuse® 9530 (all from Dow Chemical Company).

Suitable polypropylenes (PP) for use as the at least one polymer P include, for example, isotactic polypropylene (iPP), syndiotactic polypropylene (sPP), and homopolymer polypropylene (hPP), preferably having a melting temperature (Tₘ) determined by differential scanning calorimetry (DSC) according to ISO 11357-3:2018 standard using a heating rate of 2° C./min of at or above 100° C., preferably at or above 105° C., more preferably at or above 110° C.

Suitable propylene copolymers for use as the at least one polymer P include propylene-ethylene random and block copolymers and random and block copolymers of propylene and one or more C4-C20 α-olefin monomers, in particular one or more of 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of propylene-derived units, based on the weight of the copolymer.

Suitable propylene random and block copolymers are commercially available, for example, under the trade names of Intune®, and Versify (from Dow Chemical Company) and under the trade name of Vistamaxx® (from Exxon Mobil).

Further suitable propylene copolymers for use as the at least one polymer P include heterophasic propylene copolymers. These are heterophasic polymer systems comprising a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Suitable commercially available heterophasic propylene copolymers include reactor blends of the base polyolefin and the polyolefin modifier, also known as “in-situ TPOs” or “reactor TPOs or “impact copolymers (ICP)”, which are typically produced in a sequential polymerization process, wherein the components of the matrix phase are produced in a first reactor and transferred to a second reactor, where the components of the dispersed phase are produced and incorporated as domains in the matrix phase. Heterophasic propylene copolymers comprising polypropylene homopolymer as the base polymer are often referred to as “heterophasic propylene copolymers (HECO)” whereas heterophasic propylene copolymers comprising polypropylene random copolymer as the base polymer are often referred to as “heterophasic propylene random copolymers (RAHECO)”. The term “heterophasic propylene copolymer” encompasses in the present disclosure both the HECO and RAHECO types of the heterophasic propylene copolymers.

Depending on the amount of the polyolefin modifier, the commercially available heterophasic propylene copolymers are typically characterized as “impact copolymers” (ICP) or as “reactor-TPOs” or as “soft-TPOs”. The main difference between these types of heterophasic propylene copolymers is that the amount of the polyolefin modifier is typically lower in ICPs than in reactor-TPOs and soft-TPOs, such as not more than 40 wt.-%, particularly not more than 35 wt.-%. Consequently, typical ICPs tend to have a lower xylene cold soluble (XCS) content determined according to ISO 16152 2005 standard as well as higher flexural modulus determined according to ISO 178:2010 standard compared to reactor-TPOs and soft-TPOs.

Suitable heterophasic propylene copolymers include reactor TPOs and soft TPOs produced with LyondellBasell's Catalloy process technology, which are commercially available under the trade names of Adflex®, Adsyl®, Clyrell®, Hifax®, Hiflex®, and Softell®, such as Hifax® CA 10A, Hifax® CA 12A, and Hifax® CA 60 A, and Hifax CA 212 A. Further suitable heterophasic propylene copolymers are commercially available under the trade name of Borsoft® (from Borealis Polymers), such as Borsoft® SD233 CF.

Suitable ethylene vinyl acetate copolymers for use as the at least one polymer P include ethylene vinyl acetate bipolymers and terpolymers, such as ethylene vinyl acetate carbon monoxide terpolymers.

Suitable ethylene vinyl acetate bipolymers and terpolymers are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® (from Eni versalis S.p.A.), under the trade name of Levapren® (from Arlanxeo GmbH), and under the trade name of Elvaloy® (from Dupont).

Preferably, the polymeric layer comprises the at least one polymer P in an amount of at least 15 wt.-%, more preferably at least 20 wt.-%, even more preferably at least 25 wt.-%, based on the total weight of the polymeric layer.

It may further be preferred to add a compatibilizer to the polymeric layer, especially when using high amounts of the at least one powdered superabsorber polymer SAP. The compatibilizer may be added to the polymeric layer to improve the compatibility between the at least one polymer P and the superabsorber SAP. The use of such compatibilizers may be especially preferred in case the at least one polymer P comprises a polyvinylchloride resin.

According to one or more embodiments, the polymeric layer further comprises at least one compatibilizer C selected from acid anhydride-functional polymers, chlorinated polyolefines, aminosilanes, and thermoplastic polyurethanes (TPU).

If used, the at least one compatibilizer C is preferably present in the polymeric layer in an amount of not more than 30 wt.-%, preferably not more than 25 wt.-%, based on the total weight of the polymeric layer. According to one or more embodiments, the at least one compatibilizer C is preferably present in the polymeric layer in an amount of 1-30 wt.-%, preferably 2.5-25 wt.-%, more preferably 2.5-20 wt.-%, based on the total weight of the polymeric layer.

Suitable acid anhydride-functional polymers to be used as the at least one compatibilizer C include polymers having an average of more than one acid anhydride group per molecule. Furthermore, suitable acid anhydride-functional polymer may contain either polymerized or grafted acid anhydride functionality, i.e., the acid anhydride moieties may be present as part of a polymer backbone or grafted onto a polymer as a side chain. Suitable acid anhydride-functional polymers include, in particular, maleic anhydride-functional polymers, for example, olefin maleic anhydride copolymers, olefin alkyl (meth) acrylate maleic anhydride terpolymers, maleic anhydride grafted polymers, and maleic anhydride grafted copolymers.

Particularly suitable acid anhydride-functional polymers to be used as the at least one compatibilizer C include maleic anhydride grafted olefin vinyl acetate copolymers, maleic anhydride grafted ethylene-α-olefin copolymers, maleic anhydride grafted propylene-α-olefin copolymers, maleic anhydride grafted polyethylene, and maleic anhydride grafted polypropylene.

Suitable aminosilanes to be used as the at least one compatibilizer C include, for example, primary aminosilanes such as 3 aminopropyltriethoxysilane, 3-aminopropyldiethoxymethylsilane; secondary aminosilanes such as N-butyl-3-aminopropyltriethoxysilane, N-phenyl-3-aminopropyltriethoxysilane; the products of the Michael-like addition of primary aminosilanes such as 3-aminopropyltriethoxysilane or 3-aminopropyldiethoxymethylsilane onto Michael acceptors such as acrylonitrile, (meth) acrylic esters, (meth) acrylamides, maleic diesters and fumaric diesters, citraconic diesters and itaconic diesters, examples being dimethyl and diethyl N-(3-triethoxysilylpropyl) aminosuccinate;

and also analogs of the stated aminosilanes having methoxy or isopropoxy groups instead of the preferred ethoxy groups on the silicon.

The term “Michael acceptor” refers in the present document to compounds which on the basis of the double bonds they contain, activated by electron acceptor radicals, are capable of entering into nucleophilic addition reactions with primary amino groups (NH₂ groups) in a manner analogous to Michael addition (hetero-Michael addition).

Thermoplastic polyurethanes (TPU) is a class of polyurethane polymers, which are thermoplastic elastomers (TPE) consisting of linear segmented block copolymers composed of hard and soft segments. The proportion and type of hard and soft segments can be manipulated to produce a wide range TPUs having different hardness. The hard segments are isocyanates and can be classified as either aliphatic or aromatic depending on the type of isocyanate whereas the soft segments are made of a reacted polyol. Suitable thermoplastic polyurethanes to be used as the at least one compatibilizer C are commercially available, for example, under the trade name of Estane (from Lubrizol Advanced Materials).

In addition to the above-mentioned constituents, the polymeric layer may contain one or more additional constituents including, for example, UV- and heat stabilizers, antioxidants, flame retardants, inorganic fillers, dyes, pigments such as titanium dioxide, matting agents, antistatic agents, impact modifiers, biocides, and processing aids such as lubricants, slip agents, antiblock agents, and denest aids. It is however preferred, that the total amount of these types of additives comprises not more than 25 wt.-%, preferably not more than 15 wt.-%, of the total weight of the polymeric layer.

According to one or more preferred embodiments, the polymeric layer is a polyolefin-based layer, wherein the at least one polymer P is selected from ethylene copolymers, propylene copolymers, polypropylene (PP), polyethylene (PE), ethylene-vinyl acetate copolymer (EVA), preferably from propylene copolymers and polypropylene (PP), and wherein the polymeric layer comprises the at least one polymer P in an amount of at least 35 wt.-%, preferably at least 50 wt.-%, more preferably at least 75 wt.-%, based on the total weight of the polymeric layer.

According to one or more further preferred embodiments, the polymeric layer is a PVC-based layer, wherein the at least one polymer P comprises a polyvinylchloride resin P1. According to one or more embodiments, the PVC-based layer comprises at least 15 wt.-%, preferably at least 20 wt.-%, more preferably at least 30 wt.-%, even more preferably at least 40 wt.-%, still more preferably at least 50 wt.-%, based on the total weight of the PVC-based layer, of the polyvinylchloride resin P1.

Generally, the expression “the at least one component X comprises at least one component XN”, such as “the at least one polymer P comprises a polyvinylchloride resin P1” is understood to mean in the context of the present disclosure that the composition, in this case the polymeric layer, comprises a polyvinylchloride resin P1 as a representative of the at least one polymer P.

Suitable PVC resins for use as the polyvinylchloride resin P1 include ones having a K-value determined by using the method as described in ISO 1628-2-1998 standard in the range of 50-85, preferably 65-75. The K-value is a measure of the polymerization grade of the PVC-resin, and it is determined from the viscosity values of the PVC homopolymer as virgin resin, dissolved in cyclohexanone at 30° C.

Preferably, the PVC-based layer further comprises at least one plasticizer PL for the polyvinylchloride resin P1.

Suitable compounds for use as the at least one plasticizer PL include, but are not restricted to, for example, linear or branched phthalates such as di-isononyl phthalate (DINP), di-nonyl phthalate (L9P), diallyl phthalate (DAP), di-2-ethylhexyl-phthalate (DEHP), dioctyl phthalate (DOP), diisodecyl phthalate (DIDP), and mixed linear phthalates (911P). Other suitable plasticizers include phthalate-free plasticizers, such as trimellitate plasticizers, adipic polyesters, and biochemical plasticizers. Examples of biochemical plasticizers include epoxidized vegetable oils, for example, epoxidized soybean oil and epoxidized linseed oil and acetylated waxes and oils derived from plants, for example, acetylated castor wax and acetylated castor oil.

Particularly suitable phthalate-free plasticizers to be used in the waterproofing layer include alkyl esters of benzoic acid, dialkyl esters of aliphatic dicarboxylic acids, polyesters of aliphatic dicarboxylic acids or of aliphatic di-, tri- and tetrols, the end groups of which are unesterified or have been esterified with monofunctional reagents, trialkyl esters of citric acid, acetylated trialkyl esters of citric acid, glycerol esters, benzoic diesters of mono-, di-, tri-, or polyalkylene glycols, trimethylolpropane esters, dialkyl esters of cyclohexanedicarboxylic acids, dialkyl esters of terephthalic acid, trialkyl esters of trimellitic acid, triaryl esters of phosphoric acid, diaryl alkyl esters of phosphoric acid, trialkyl esters of phosphoric acid, and aryl esters of alkanesulphonic acids.

According to one or more embodiments, the at least one plasticizer PL is selected from the group consisting of phthalates, trimellitate plasticizers, adipic polyesters, and biochemical plasticizers.

Preferably, the ratio of the total weight of the polyvinylchloride resin P1 to the total weight of the at least one plasticizer PL is in the range of 3:1 to 1:1.5, preferably 2:1 to 1:1.3, more preferably 2:1 to 1:2.

According to one or more embodiments, the polymeric layer is a PVC-based layer, wherein the at least one polymer P comprises, in addition to the polyvinyl chloride resin P1, at least one polymer P2 that is not a polyvinylchloride resin, wherein the at least one polymer P2 is preferably selected from ethylene copolymers, propylene copolymers, polypropylene (PP), polyethylene (PE), ethylene-vinyl acetate copolymer (EVA), more preferably ethylene-vinyl acetate copolymer (EVA).

It may be preferred that the ratio of the total weight of the polyvinyl chloride resin P1 to total weight of the at least one polymer P2 is in the range of 5:1 to 1:3, more preferably 4:1 to 1:2, even more preferably 3:1 to 1:2.

According to one or more preferred embodiments, the polymeric layer is selected from the polyolefin-based layer and the PVC-based layer.

According to a second embodiment, the waterproofing layer (2) is a bitumen layer comprising, in addition to the at least one powdered superabsorber polymer SAP, bitumen B and at least one modifying polymer MP.

Preferably, the bitumen layer comprises the bitumen B in an amount of at least 15 wt.-%, preferably at least 35 wt.-%, based on the total weight of the bitumen layer.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-200 dmm, more preferably 70-100 dmm and/or a softening point determined by Ring and Ball measurement conducted according to DIN EN 1238 standard in the range of 30-100° C., preferably 50-100° C.

Preferably, the at least one modifying polymer MP is selected from atactic polypropylene (APP), amorphous polyolefins (APO), styrene block copolymers, and rubbers.

The term “amorphous polyolefin (APO)” refers in the present disclosure to polyolefins to having a low crystallinity degree determined by a differential scanning calorimetry (DSC) measurements, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates polyolefins lacking a crystalline melting point (Tₘ) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the modifying polymer MP include, particularly styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the modifying polymer MP include at least styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Suitable rubbers for use as the modifying polymer MP include, for example, styrene-butadiene rubber (SBR), ethylene propylene diene monomer (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM), polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to one or more embodiments, the bitumen layer comprises the at least one modifying polymer MP in an amount of 5-35 wt.-%, preferably 10-30 wt.-%, based on the total weight of the bitumen layer.

Preferably, the waterproofing layer (2) has a thickness of not more than 1.5 mm, more preferably not more than 1 mm. The thickness of the waterproofing layer can be measured by using the measurement method as defined in DIN EN 1849-2 standard.

According to one or more embodiments, the waterproofing layer (2) has a thickness of 0.05-1.5 mm, preferably 0.1-1.2 mm, more preferably 0.1-1 mm, even more preferably 0.1-0.8 mm, still more preferably 0.1-0.7 mm.

There are no strict limitations for the width and length of the waterproofing layer, and these depend on the intended use of the sealing element. For example, the sealing element can be provided in form of a narrow strip, wherein the waterproofing layer has a width, for example, of 10-500 mm, such as 50-350 mm, particularly 75-300 mm. On the other hand, the sealing element can also be provided in form of a broad sheet, wherein the waterproofing layer has a width of, for example, of 0.75-5 m, such as 1-3.5 m, particularly 1-2.5 m. Generally, the sealing elements of the present invention are provided in a form of prefabricated articles, which can be delivered to the construction site in form of rolls, which are then unwounded to provide sheets having a suitable length.

According to one or more embodiments, the waterproofing layer has a width of 0.1-5 m, preferably 0.25-3.5 m, more preferably 0.5-2 m, even more preferably 0.75-1.5 m.

Preferably, the sealing element has a water vapor diffusion-equivalent air layer thickness (Sd) value determined according to EN ISO 12572:2017-05 standard of not more than 10 m, preferably not more than 5 m.

According to one or more embodiments, the sealing element is a roof breather membrane or a wall breather membrane. Wall breather membranes are also known as “house wrappings”.

It may further be preferred to include a reinforcing layer to structure of the sealing element. Particularly in case of very thin waterproofing layers, such as those having a thickness of <0.3 mm, the use of one or more reinforcing layers may be preferred. The reinforcing layer may be fully embedded into the waterproofing layer or adhered to one of the major surfaces of the waterproofing layer. The expression “fully embedded” is understood to mean that the reinforcing layer is fully covered by the matrix of one of the waterproofing layer.

According to one or more embodiments, the sealing element comprises a reinforcing layer that is fully embedded into the waterproofing layer or adhered to one of the major surfaces of the waterproofing layer, wherein the reinforcing layer is selected from non-woven fabrics, woven fabrics, and laid scrims comprising synthetic organic and/or inorganic fibers.

The term “non-woven fabric” refers in the present disclosure to materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric. Typical materials for the non-woven fabrics include synthetic organic and inorganic fibers.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90+5°, towards each other thereby forming interstices, wherein the interstices occupy more than 60% of the entire surface area of the laid scrim.

According to one or more embodiments, the synthetic organic fibers of the reinforcing layer are selected from polyethylene, polypropylene, polyester, nylon, and aramid fibers.

According to one or more embodiments, the inorganic fibers of the reinforcing layer are selected from glass, carbon, metal, and wollastonite fibers.

According to one or more embodiments, the sealing element comprises a first and a second reinforcing layer selected from non-woven fabrics, woven fabrics, and laid scrims comprising synthetic organic and/or inorganic fibers, wherein the first reinforcing layer is adhered to the first major surface of the waterproofing layer and the second reinforcing layer is adhered to the second major surface of the waterproofing layer.

Preferably, the reinforcing layer(s) is/are adhered to a surface of the waterproofing layer without the use of adhesives.

According to one or more embodiments, the sealing element comprises a reinforcing layer selected from non-woven fabrics, woven fabrics, and laid scrims comprising synthetic organic and/or inorganic fibers, wherein the reinforcing layer has been thermally laminated to one of the major surfaces of the waterproofing layer, such as to the first major surface of the waterproofing layer, in a manner that gives direct bonding between the reinforcing layer and the waterproofing layer.

The term “thermal lamination” refers in the present disclosure to a process, in which the layers are bonded to each by the application of thermal energy. In particular, the term “thermal lamination” refers to a process comprising partially melting at least one of the layers upon application of thermal energy followed by a cooling step, which results in formation of a physical bond between the layers without using an adhesive.

According to one or more embodiments, the sealing element further comprises:
iii) A pressure sensitive adhesive layer (4).

The term “pressure sensitive adhesive layer” designates in the present disclosure an adhesive layer, which is composed of one or more pressure sensitive adhesives.

The term “pressure sensitive adhesive (PSA)” designates in the present disclosure viscoelastic materials, which adhere immediately to almost any kind of substrates by application of light pressure, and which are permanently tacky. The tackiness of an adhesive layer can be measured, for example, as a loop tack.

The sealing elements according to these embodiments comprising a pressure sensitive adhesive layer are suitable for use as self-adhering sealing elements, particularly as self-adhering roof breather or wall breather membranes. The term “self-adhering” is understood to mean that the sealing element can be adhered to a surface of a substrate via a pre-applied, such as a factory-applied, pressure sensitive adhesive layer. Typically, the pre-applied pressure sensitive adhesive layer is covered with a release liner to protect the adhesive layer from environmental factors and to enable storing of the sealing element in form of a roll.

Preferably, the pressure sensitive adhesive layer (4) has a loop tack adhesion to a glass plate measured at a temperature of 23° C. of at least 2.5 N/25 mm, preferably at least 5 N/25 mm, more preferably at least 10 N/25 mm.

Preferably, the pressure sensitive adhesive layer has a thickness of at least 50 μm, more preferably at least 100 μm. Such adhesive layers have been found out to enable sufficient bonding to uneven surfaces of substrates, such as to concrete and plywood substrates. According to one or more embodiments, the pressure sensitive adhesive layer has a thickness of 50-500 μm, preferably 75-350 μm, more preferably 100-300 μm.

The pressure sensitive adhesive layer may be applied to respective surfaces of the waterproofing layer by using any conventional techniques, such as by using lamination, extrusion, calendaring, spread coating, slot die coating, extrusion coating, roller coating, direct gravure coating, offset gravure coating, reverse gravure roll coating, powder dispersion, or spray lamination techniques.

The pressure sensitive adhesive layer is preferably selected to have Sd value that is equal or smaller than the Sd value of the waterproofing layer. This can be achieved by using a pressure sensitive adhesive having suitable water vapor permeability properties or by using a discontinuous adhesive layer. The term “discontinuous adhesive layer” is understood to mean that the that the pressure sensitive adhesive has been applied to the waterproofing layer in a pattern composed of adhesive coated areas and adhesive free areas (voids).

Suitable pressure sensitive adhesives for use in the pressure sensitive adhesive layer (4) include, for example, acrylic adhesives and synthetic rubber-, natural rubber-, and bitumen-based adhesives.

Suitable rubbers for use in a synthetic rubber-based pressure sensitive adhesive include for example, styrene block copolymers, vinyl ether polymers, styrene-butadiene rubber (SBR), ethylene propylene diene monomer (EPDM), butyl rubber, polyisoprene, polybutadiene, natural rubber, polychloroprene rubber, ethylene-propylene rubber (EPR), nitrile rubber, acrylic rubber, ethylene vinyl acetate rubber, or silicone rubber.

Suitable bitumen-based pressure sensitive adhesives typically comprise one of more different types of bitumen materials mixed with one or more modifying polymers to improve the resistance to UV-radiation, toughness, and flexibility at low temperatures.

In addition to the above-mentioned components, suitable pressure sensitive adhesives typically comprise one or more additional constituents including, for example, tackifying resins, waxes, and additives, for example, UV-light absorption agents, UV- and heat stabilizers, optical brighteners, pigments, dyes, and desiccants.

According to one or more embodiments, the pressure sensitive adhesive layer (4) is an acrylic pressure sensitive adhesive layer. The term “acrylic adhesive” designates in the present disclosure adhesive compositions containing one or more acrylic polymers as the main polymer component.

The term “acrylic polymer” designates in the present disclosure homopolymers, copolymers and higher inter-polymers of an acrylic monomer with one or more further acrylic monomers and/or with one or more other ethylenically unsaturated monomers. The term “monomer” refers to a compound that chemically bonds to other molecules, including other monomers, to form a polymer. The term “acrylic monomer” refers to monomers having at least one (meth) acryloyl group in the molecule. The term “(meth) acryloyl” designates methacryloyl or acryloyl. Accordingly, the term “(meth) acrylic” designates methacrylic or acrylic. A (meth) acryloyl group is also known as (meth) acryl group.

The polymer chains of the acrylic polymers contained in the pressure sensitive adhesive layer may be non-crosslinked or physically or chemically crosslinked. Furthermore, the polymer chains of the acrylic polymers may be present in the pressure sensitive adhesive layer as part of a chemically crosslinked polymer network comprising other polymers than acrylic polymers or as part of an interpenetrating or semi-interpenetrating polymer network (IPN).

The term “interpenetrating polymer network” refers to a polymer network comprising two or more dissimilar polymers that are in network form, i.e., chemically, or physically crosslinked. In an IPN, the polymer chains are not chemically bonded, but they are physically entangled by permanent chain entanglements. In a semi-interpenetrating polymer network, the polymer network and a linear or branched polymer penetrate each other at the molecular level.

Acrylic pressure sensitive adhesive layers have been found out to have relatively low Sd values, which enables their application in form of continuous adhesive layer to provide self-adhering breather membranes. Continuous adhesive layers are generally preferred since they can be produced using standard coating techniques, such as extrusion coating for hot melt based adhesives, or application by using transfer tapes for solvent and water based adhesives.

According to one or more embodiments, pressure sensitive adhesive layer (4) comprises at least 35 wt.-%, preferably at least 50 wt.-%, more preferably at least 75 wt.-%, even more preferably at least 85 wt.-%, of at least one acrylic polymer AP, based on the total weight of the pressure sensitive adhesive layer (4).

Examples of suitable acrylic monomers for use in the at least one acrylic polymer AP include, for example, (meth) acrylates, (meth) acrylic acid or derivatives thereof, for example, amides of (meth)acrylic acid or nitriles of (meth) acrylic acid, and (meth) acrylates with functional groups such as hydroxyl group-containing (meth) acrylates and alkyl (meth) acrylates.

According to one or more embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of at least one acrylic monomer AM of formula (I):

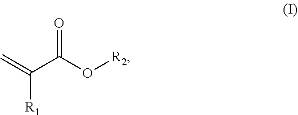

where
R₁ represents a hydrogen or a methyl group; and
R₂ represents a branched, unbranched, cyclic, acyclic, or saturated alkyl group having from 2 to 30 carbon atoms.

Examples of suitable acrylic monomers of formula (I) include methyl acrylate, methyl methacrylate, ethyl acrylate, ethoxy ethoxy ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl (meth)acrylate, 2-hydroxypropyl (meth) acrylate, 3-hydroxypropyl (meth) acrylate, 2-hydroxybutyl (meth) acrylate, 4-hydroxybutyl butyl (meth) acrylate, 2-hydroxy-hexyl (meth) acrylate, 6-hydroxy hexyl (meth) acrylate, 8-hydroxyoctyl (meth) acrylate, 10-hydroxydecyl (meth) acrylate, 12-hydroxylauryl (meth) acrylate. Further suitable hydroxyl group containing acrylic monomers include (4-hydroxymethyl cyclohexyl) methyl acrylate, polypropylene glycol mono(meth) acrylate, N-hydroxyethyl (meth) acrylamide, and N-hydroxypropyl (meth) acrylamide, esters of hydroxyethyl (meth) acrylate and phosphoric acid, and trimethoxysilylpropyl methacrylate.

According to one or more embodiments, the monomer mixture used for obtaining the at least one acrylic polymer AP comprises not more than 25 wt.-%, preferably not more than 20 wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of the at least one acrylic polymer AP include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of especially suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, vinyl acetate, and acryloyl morpholine.

According to one or more embodiments, the monomer mixture used for obtaining the at least one acrylic polymer AP comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth) acrylamides, N-substituted (meth) acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth) acrylates.

According to one or more embodiments, the at least one acrylic polymer AP has a glass transition temperature (Tg), determined by dynamical mechanical analysis (DMA) using an applied frequency of 1 Hz and a strain level of 0.1%, of below 0° C., preferably below −20° C. and/or a number average molecular weight (Mn) determined by gel permeation-chromatography using polystyrene as standard of 50ß000-1′000′000 g/mol, preferably 100′000-750′000 g/mol, more preferably 150′000-500′000 g/mol.

According to one or more embodiments, the pressure sensitive adhesive layer (4) is a dried layer of a water- or solvent-based acrylic pressure sensitive adhesive composition or a cured layer of a UV- or electron beam curable acrylic pressure sensitive adhesive composition.

The term “water-based pressure sensitive adhesive composition” designates in the present disclosure pressure sensitive adhesives, which have been formulated as an aqueous dispersion, an aqueous emulsion, or as an aqueous colloidal suspension. The term “aqueous dispersion” or “aqueous emulsion” refers to dispersions or emulsions containing water as the main continuous (carrier) phase. Typically, a water-based pressure sensitive adhesive composition comprises surfactants to stabilize the hydrophobic polymer particles and to prevent these from coagulating with each other.

The term “solvent-based pressure sensitive adhesive composition” designates in the present disclosure pressure sensitive adhesives comprising acrylic polymers, which are substantially completely dissolved in the organic solvent(s). Typically, the organic solvent(s) comprise at least 20 wt.-%, preferably at least 30 wt.-%, more preferably at least 40 wt.-%, of the total weight of the solvent-based pressure sensitive adhesive composition. The term “organic solvent” refers in the present document to organic substances that are liquid at a temperature of 25° C., are able to dissolve another substance at least partially, and have a standard boiling point of not more than 225° C., preferably not more than 200° C. The term “standard boiling point” refers in the present disclosure to boiling point measured at a pressure of 1 bar. The standard boiling point of a substance or composition can be determined, for example, by using an ebulliometer.

Suitable organic solvents for the solvent-based pressure sensitive adhesive composition include, for example, alcohols, aliphatic and aromatic hydrocarbons, ketones, esters, and mixtures thereof. It is possible to use only a single organic solvent or a mixture of two or more organic solvents. Suitable solvent-based pressure sensitive adhesive compositions are substantially water-free, for example, containing less than 10 wt.-%, preferably less than 5 wt.-%, more preferably less than 1 wt.-% of water, based on the total weight of the solvent-based pressure sensitive adhesive.

The term “UV-curable acrylic pressure sensitive adhesive composition” refers to acrylic pressure sensitive adhesives, which can be cured by initiation of photochemical curing reactions by UV-irradiation. In analogy, the term “electron beam curable acrylic pressure sensitive adhesive composition” refers to acrylic pressure sensitive adhesives, which can be cured by initiation of photochemical curing reactions by accelerated electrons. The term “curing” in the present disclosure to chemical reactions comprising forming of bonds resulting, for example, in chain extension and/or crosslinking of polymer chains.

According to one or more embodiments, the sealing element further comprises a release liner (5) covering the outward facing surface of the pressure sensitive adhesive layer (4) on the side opposite to the side of the waterproofing layer (2).

Suitable materials for the release liner include, for example, Kraft paper, polyethylene coated paper, silicone coated paper as well as polymeric films, for example, polyethylene, polypropylene, and polyester films coated with polymeric release agents selected from silicone, silicone urea, urethanes, waxes, and long chain alkyl acrylate release agents.

The sealing element of the present invention can be produced by using any conventional techniques including extrusion, co-extrusion, and lamination techniques, wherein the details of the production method depend on the embodiment of the sealing element.

### DETAILED DESCRIPTION OF THE DRAWINGS

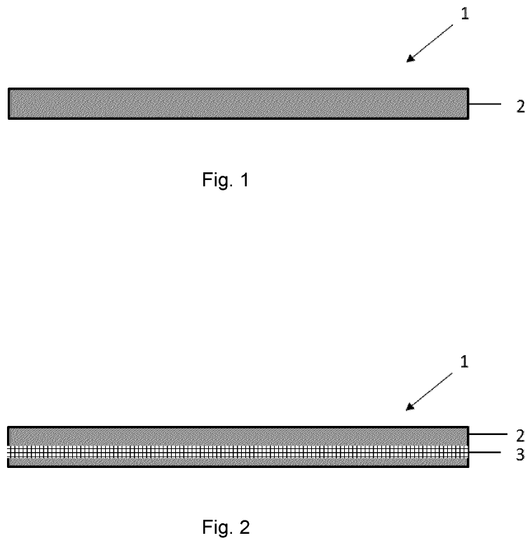

According to one or more embodiments, the sealing element (1) is composed of the waterproofing layer (2), as shown in FIG. 1.

According to one or more further embodiments, the sealing element (1) is composed of the waterproofing layer (2) and a reinforcement layer (3) fully embedded into the waterproofing layer (2), as shown in FIG. 2.

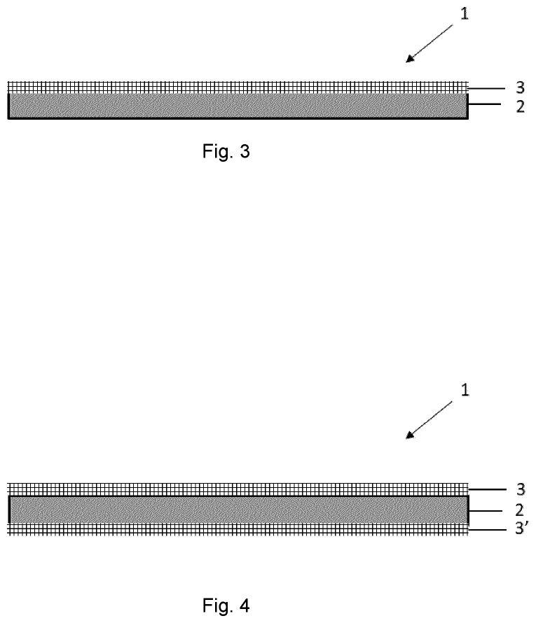

According to one or more further embodiments, the sealing element (1) is composed of the waterproofing layer (2) and a reinforcement layer (3) adhered to one of the major surfaces of the waterproofing layer (2), as shown in FIG. 3.

According to one or more further embodiments, the sealing element (1) is composed of the waterproofing layer (2), a first reinforcement layer (3) adhered to the first major surfaces of the waterproofing layer (2) and a second reinforcement layer (3′) adhered to the second major surfaces of the waterproofing layer (2), as shown in FIG. 4.

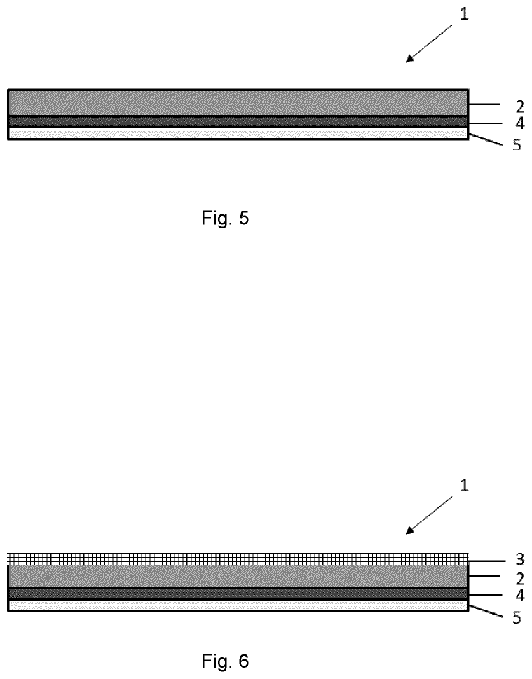

According to one or more further embodiments, the sealing element (1) is a self-adhering sealing element composed of the waterproofing layer (2), a pressure sensitive adhesive layer (4) covering the second major surface of the waterproofing layer (2), and a release liner (5) covering the outward facing surface of the pressure sensitive adhesive layer (4) on the side opposite to the side of the waterproofing layer (2), as shown in FIG. 5.

According to one or more further embodiments, the sealing element (1) is composed of the waterproofing layer (2), a reinforcement layer (3) adhered on the first major surface of the waterproofing layer (2), a pressure sensitive adhesive layer (4) covering the second major surface of the waterproofing layer (2), and a release liner (5) covering the outward facing surface of the pressure sensitive adhesive layer (4) on the side opposite to the side of the waterproofing layer (2), as shown in FIG. 6.

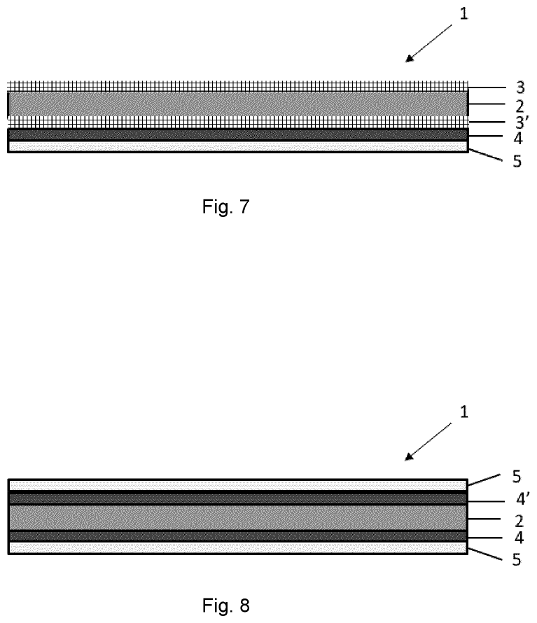

According to one or more further embodiments, the sealing element (1) is a self-adhering sealing element composed of the waterproofing layer (2), a first reinforcement layer (3) adhered to the first major surfaces of the waterproofing layer (2) and a second reinforcement layer (3′) adhered to the second major surfaces of the waterproofing layer (2), a pressure sensitive adhesive layer (4) covering one of the outward facing surface of the second reinforcing layer (3′) on the side opposite to the side of the waterproofing layer (2), and a release liner (5) covering the outward facing surface of the pressure sensitive adhesive layer (4) on the side opposite to the side of the waterproofing layer (2), as shown in FIG. 7.

According to one or more further embodiments, the sealing element (1) is a double-sided self-adhering sealing element composed of the waterproofing layer (2), a first pressure sensitive adhesive layer (4) covering the second major surface of the waterproofing layer (2), a first release liner (5) covering the outward facing surface of the first pressure sensitive adhesive layer (4) on the side opposite to the side of the waterproofing layer (2), a second pressure sensitive adhesive layer (4′) covering the first major surface of the waterproofing layer (2), and a second release liner (5) covering the outward facing surface of the second pressure sensitive adhesive layer (4′) on the side opposite to the side of the waterproofing layer (2), as shown in FIG. 8.

Another subject of the present invention is a building structure comprising:
I) A roof or a wall substrate (6),
II) A sealing element (1) according to the present invention, and
III) An insulation board (7), wherein the sealing element (1) is arranged between the roof or wall substrate (6) and the insulation board (7).

Suitable insulation boards to be used in the building structure include, for example, foamed insulation boards, such as expanded polystyrene (EPS), extruded expanded polystyrene (XPS), and polyisocyanurate (PIR) boards.

Preferably, the insulation board comprises at least one foam panel having a closed cell structure. Suitable foam panels having a closed cell structure include molded expanded polystyrene (EPS) foam panels, extruded expanded polystyrene (XPS) foam panels, polyurethane foam panels (PUR), and polyisocyanurate (PIR) foam panels.

The thickness of the insulation board is not particularly restricted. It may be preferable that the insulation board has a thickness determined by using the measurement method as defined in DIN EN 1849-2 standard of 5-500 mm, preferably 10-350 mm, even more preferably 25-150 mm.

According to one or more embodiments, the insulation board comprises at least one foam panel having a closed cell structure selected from the group consisting of molded expanded polystyrene (EPS) foam panel, extruded expanded polystyrene (XPS) foam panel, polyurethane foam panel (PUR), and polyisocyanurate (PIR) foam panel, preferably having a density in the range of 10-150 g/l, more preferably 15-100 g/l, even more preferably 25-75 g/l.

Still another subject of the present invention is use of the sealing element of the present invention as a roof breather or wall breather membrane.

### EXAMPLES

The following materials and compounds shown in Table 1 were used in the examples.

TABLE 1

| | | |
|---|---|---|
| Polymer P1 | Hifax ® CA 60 A | LyondellBasell |
| Polymer P2 | Polyvinylchloride resin, K value 70 | Ivonyn |
| Polymer P3 | Baymod ® L 6515 VP, blend of PVC and | Arlanxeo |
| | ethylene vinyl acetate (VA) copolymer, | |
| | VA content 65% | |
| Superabsorber SAP | Hysorb ® T 6600 | BASF |
| Compatibilizer C1 | Estane ® ALR CL87A-V, thermoplastic | Lubrizol |
| | polyurethane (TPU) | |
| Compatibilizer C2 | KH550 ®, aminosilane | Zhejiang Feidian |
| | | Chemical Co., Ltd |
| Plasticizer | Diisononyl phthalate (DINP) | Evonik Industries |
| Thermal stabilizer | Lead free stabilizer | Chemson |
| Pigment | TiO₂ | Kronos |

### Preparation of Sealing Elements

The polymer compositions were melt-processed in a two roll mill and then pressed into sheets having a thickness of ca. 0.6-0.8 mm, using a laboratory curing press at a temperature of 190° C. and using a pressing time of 3 minutes at 120 bar.

The superabsorber polymer, having originally an average particle size of ca. 500 μm, was milled with a Fritch Pulverisette 14′ rotation mill to an average particle size of ca. 100 μm before being mixed with the other constituents of the polymeric layer.

The compositions of the reference and inventive sealing elements (waterproofing layers) are show in Table 2.

### Water Vapor Permeability, Tensile Strength and Elongation at Break

Water vapor permeability (WVP) was determined using a Gintronic GraviTest machine and a measurement method according to EN 1931:2001-03 standard. The Sd values were then calculated from the measured WVP values.

The tensile strength and elongation at break were measured according to ISO 527-3:2018 standard at a temperature of 21° C. using a Zwick tensile tester and a cross head speed of 100 mm/min.

The results obtained with refence and inventive sealing devices are shown in Table 2.

TABLE 2

| Composition [wt.- %] | Ref-1 | Ex-1 | Ex-2 | Ex-3 | Ref-1 | Ex-4 | Ex-5 | Ex-6 | Ex-7 | Ex-8 |
|---|---|---|---|---|---|---|---|---|---|---|
| P1 (Hifax) | 100.00 | 90.91 | 83.33 | 71.43 | 0.00 | 0.00 | 0.00 | 0.00 | 0.00 | 0.00 |
| P2 (PVC) | 0.00 | 0.00 | 0.00 | 0.00 | 53.76 | 37.59 | 30.08 | 26.14 | 22.56 | [symbol] |
| P3 (PVC-EVA) | 0.00 | 0.00 | 0.00 | 0.00 | 0.00 | 0.00 | 7.52 | 13.07 | 0.00 | 0.00 |
| SAP | 0.00 | 9.09 | 16.67 | 28.57 | 0.00 | 30.08 | 30.08 | 26.14 | 30.08 | [symbol] |
| C1 (TPU) | 0.00 | 0.00 | 0.00 | 0.00 | 0.00 | 0.00 | 0.00 | 6.54 | 15.04 | 0.00 |
| C2 (Aminosilane) | 0.00 | 0.00 | 0.00 | 0.00 | 0.00 | 0.00 | 0.00 | 0.00 | 0.00 | [symbol] |
| Plasticizer | 0.00 | 0.00 | 0.00 | 0.00 | 34.95 | 24.44 | 24.44 | 21.24 | 24.44 | [symbol] |
| Thermal stabilizer | 0.00 | 0.00 | 0.00 | 0.00 | 2.69 | 1.88 | 1.88 | 1.63 | 1.88 | [symbol] |
| Pigment | 0.00 | 0.00 | 0.00 | 0.00 | 8.60 | 6.02 | 6.02 | 5.23 | 6.02 | [symbol] |
| Total | 100.00 | 100.00 | 100.00 | 100.00 | 100.00 | 100.00 | 100.00 | 100.00 | 100.00 | [symbol] |
| Properties | | | | | | | | | | |
| Thickness [mm] | 0.6 | 0.7 | 0.75 | 0.7 | 0.5 | 0.5 | 0.8 | 0.5 | 0.75 | [symbol] |
| WVP [g/m² day] | 0.41 | 2.43 | 9.67 | 12.68 | 4.15 | 14.02 | 10.49 | 14.71 | 17.04 | 10.39 |
| Sd value [m] | 91.1 | 15.4 | 3.88 | 2.96 | 9 | 2.66 | 3.56 | 2.54 | 2.19 | 3.59 |
| Tensile strength [MPa] | 12.9 | 5.1 | 3.9 | 4 | 15.3 | 7.8 | 4 | 8.9 | 11.2 | 10 |
| Elongation at break [%] | 856 | 36 | 37 | 51 | 282 | 163 | 153 | 219 | 275 | 82 |

[symbol]

indicates data missing or illegible when filed

1. A sealing element comprising:
i) a waterproofing layer having a first and a second major surface and comprising at least one powdered superabsorber polymer SAP,
ii) optionally a reinforcement layer fully embedded into the waterproofing layer or adhered to one of the major surfaces of the waterproofing layer,
wherein the waterproofing layer is a polymeric layer comprising at least one polymer P or a bitumen layer comprising bitumen B and at least one modifying polymer MP.

2. The sealing element according to claim 1, wherein the waterproofing layer comprises 2.5-45 wt.-%, based on the total weight of the waterproofing layer, of the at least one powdered superabsorber polymer SAP.

3. The sealing element (H) according to claim 1, wherein the at least one powdered superabsorber polymer SAP has a median particle size d₅₀ in the range of 5-150 μm.

4. The sealing element (1) according to claim 1, wherein the waterproofing layer (2) is not tacky to touch at a temperature of 23° C.

5. The sealing element (1) according to claim 1, wherein the at least one polymer P is selected from polyolefins, halogenated polyolefins, polyvinylchloride (PVC), rubbers, and ketone ethylene esters (KEE).

6. The sealing element according to claim 1, wherein the polymeric layer comprises the at least one polymer P in an amount of at least 15 wt.-%, based on the total weight of the polymeric layer.

7. The sealing element according to claim 1, wherein the polymeric layer further comprises at least one compatibilizer C selected from acid anhydride-functional polymers, chlorinated polyolefines, aminosilanes, and thermoplastic polyurethanes (TPU).

8. The sealing element according to claim 1, wherein the polymeric layer is a PVC-based layer, wherein the at least one polymer P comprises a polyvinylchloride resin P1.

9. The sealing element according to claim 8, wherein the PVC-based layer comprises at least 15 wt.-%, based on the total weight of the PVC-based layer, of the polyvinylchloride resin P1.

10. The sealing element according to claim 1, wherein the bitumen layer comprises the bitumen B in an amount of at least 15 wt.-%, based on the total weight of the bitumen layer.

11. The sealing element according to claim 1, wherein the at least one modifying polymer MP is selected from atactic polypropylene (APP), amorphous polyolefins (APO), styrene block copolymers, and rubbers.

12. The sealing element according to claim 1, wherein the waterproofing layer has a thickness of not more than 1.5 mm.

13. The sealing element according to claim 1, wherein the sealing element is a roof breather or a wall breather membrane.

14. The sealing element according to claim 1 comprising the reinforcing layer selected from non-woven fabrics, woven fabrics, and laid scrims comprising synthetic organic and/or inorganic fibers.

15. The sealing element according to claim 1 further comprising:
iii) a pressure sensitive adhesive layer.

16. The sealing element according to claim 12, wherein the pressure sensitive adhesive layer is an acrylic pressure sensitive adhesive layer.

17. A building structure comprising:
I) a roof or a wall substrate,
II) a sealing element according to claim 1, and
III) an insulation board, wherein the sealing element is arranged between the roof or wall substrate and the insulation board.

18. A roof breather or wall breather membrane comprising the sealing element according to claim 1.
